(19) United States
(12) Patent Application Publication
(10) Pub. No.: US 2025/0376226 A1
(43) Pub. Date: Dec. 11, 2025

(54) TOWABLE TRAILER WITH AN ADAPTABLE DECK ASSEMBLY AND METHOD OF USE

(71) Applicant: RedHead Boats LLC, Eagle Mountain, UT (US)

(72) Inventor: Brandon King, Eagle Mountain, UT (US)

(73) Assignee: RedHead Boats LLC, Eagle Mountain, UT (US)

(21) Appl. No.: 19/230,068

(22) Filed: Jun. 5, 2025

Related U.S. Application Data
(60) Provisional application No. 63/656,499, filed on Jun. 5, 2024.
(60) Provisional application No. 63/656,476, filed on Jun. 5, 2024.

(51) Int. Cl. B62D 63/06; B60P 3/06; B60P 3/10; B60P 3/32; B62D 29/00; B62D 63/08

(52) U.S. Cl. CPC B62D 63/061; B60P 3/06; B62D 29/008; B62D 63/08; B60P 3/10; B60P 3/32

(57) ABSTRACT

A trailer system having an adaptable trailer-deck assembly which incorporates rails to increase the surface area of attachment points, and a plurality of sleeve members. This modular design allows for a plurality of attachment and insertion points for a variety of accessories for both residential and recreational use. The arrangement of one or more sleeve members may align with similarly-oriented sleeve members on a watercraft for ease of transition between vehicles. The trailer system may be folded into a stowable orientation via a winch mechanism.

### CROSS-REFERENCE TO RELATED APPLICATIONS

This is a non-provisional application that claims priority to U.S. Provisional Patent Application No. 63/656,476 filed Jun. 5, 2024. The disclosure of that application is specifically incorporated by reference herein for all that it discloses and teaches.

### BACKGROUND

### 1. The Field of the Invention

Aspects of the present invention relate generally to a towable trailer. More specifically, some embodiments of the invention relate to a towable trailer configured to bear an adaptable trailer-deck assembly, such as an adaptable trailer-deck assembly which aligns with an adaptable watercraft-deck assembly having two or more hulls.

### 2. Background

Most trailers are unpowered vehicles towed by another vehicle and are used commercially and residentially. Residential trailers, like utility trailers, are used as a substitution for a truck bed to carry any number of home supplies. Recreational trailers are used to transport any recreational equipment like boats, ATVs, and motorcycles, as well as lodgings like tent and camper trailers.

In the field of residential and recreational use trailers, many are inhibited from owning a trailer due to the need for year round storage, the intimidation of use, and the cost per use of specialized trailers.

Generally, residential and recreational trailers are specialized for a singular purpose, like boat trailers or tent trailers. Some are designed to solve a plurality of problems, like a folding/utility trailer.

The cost of year-round storage of a trailer is substantial and multiplied by the number of specialized trailers a residence has, a boat trailer, camper trailer and a utility trailer each take up a parking spot for storage.

### SUMMARY

The present disclosure describes a trailer apparatus. In one aspect, a tiltable and standing multipurpose trailer, which may be used for recreational and residential use, has size dimensions that allow the trailer to be towed behind a car. The trailer may have at least one mechanical winch coupled to at least one cable, which may be operable by a user to tilt the trailer to facilitate the loading and unloading of cargo and which may also be operable by a user to stand the trailer in a vertical, storable configuration. The trailer deck may incorporate an adaptable trailer-deck assembly using rails, comprised of modular aluminum extrusion in some embodiments, and a pattern of sleeves to accept inserts on the trailer deck. The trailer deck may be modular; for this patent application, the use of “modular” to describe the trailer deck means that the deck may be configured to receive various attachable devices. The trailer deck may be a modular platform configured to accept multipurpose attachments to the trailer deck. The rails may provide tiedown or attachment points along the length of the rails or along the surfaces of the rails for securing cargo or attaching multipurpose accessories.

The trailer deck may have a grouping of sleeve members to accept inserts, such as insertable connecting members, for coupling a tent to the trailer, for converting the trailer into a camper, for converting the trailer into a utility trailer, or for detachably coupling at least one attachable device to the trailer to increase the functionality of the trailer; the trailer deck may support a variety of cargo loads typically used by households engaging in outdoor recreation.

A trailer decking may be coupled to the trailer frame; trailer decking may be made from plastics or composite decking; trailer decking may provide a substantially flat surface to support cargo and people.

In one aspect, a trailer built with an adaptable trailer-deck assembly may be detachably coupled to accessories to convert the trailer into a multipurpose platform, potentially reducing or eliminating the need for specialized single-purpose trailers, and reducing per use cost. In some embodiments, the trailer may include a tongue pulley with a rope originating from the winch through the front pulley, running underneath the trailer and connecting to the back end of the trailer. This system allows the user to easily fold and store the trailer using minimal effort.

The trailer may be towed by a variety of vehicles, including many cars, and when not attached to a tow vehicle the trailer can be maneuvered by one person into a garage and into an upright storage position.

### BRIEF DESCRIPTION OF THE DRAWINGS

The preferred embodiments of the present invention will be described in conjunction with the appended drawings. Like designations denote like elements, and:

FIG. 1 is a plan view illustrating a trailer according to an embodiment of the present invention;

FIG. 2 is a left side view of the trailer of FIG. 1 illustrating an embodiment of the present invention;

FIG. 3 is a top right perspective view of the trailer of FIG. 1, illustrating an embodiment of the present invention;

FIG. 4 is a right side view of the trailer depicted in FIG. 1 in a partially-folded configuration, illustrating an embodiment of the present invention;

FIG. 5 is a top right perspective partial view of the trailer of FIG. 1, illustrating an embodiment of the present invention; the shaded panel depicting the location of a cross-sectional plane with portions of the plurality of lateral cross members and a plurality of sleeve members removed by the cross-sectional plane;

FIG. 5 is a right side partial view of the trailer of FIG. 5, illustrating an embodiment of the present invention;

FIG. 6 is a top right perspective partial view of the trailer of FIG. 1, illustrating an embodiment of the present invention; the shaded panel depicts the location of a central cross-sectional plane with half of the trailer being removed by the cross-sectional plane;

FIG. 6 is a right side view of the trailer of FIG. 6, illustrating an embodiment of the present invention, depicting a portion of a plurality of sleeve members (which may be smaller as depicted here), showing a longitudinal cross-member, illustrating an embodiment of the present invention;

FIG. 7 is a right side view of the trailer of FIG. T1;

FIG. 8 is a right side view of the trailer of FIG. 7, wherein the trail is in a first partially-folded configuration, illustrating an embodiment of the present invention;

FIG. 9 is a right side view of the trailer of FIG. 7, wherein the trail is in a second partially-folded configuration, illustrating an embodiment of the present invention;

FIG. 10 is a right side view of the trailer of FIG. 7, wherein the trail is in a third partially-folded configuration, illustrating an embodiment of the present invention;

FIG. 11 is a right side view of the trailer of FIG. 7, wherein the trail is in a fourth partially-folded configuration, illustrating an embodiment of the present invention;

FIG. 12 is a right side view of the trailer of FIG. 7, wherein the trail is in a fifth partially-folded configuration, illustrating an embodiment of the present invention;

FIG. 13 is a top view of a trailer deck showing a grouping of sleeve members, illustrating an embodiment of the present invention;

FIG. 14 is a top view of a trailer deck showing a grouping of sleeve members, illustrating an embodiment of the present invention;

FIG. 15 is right side perspective view of a trailer frame without decking, illustrating a portion of an embodiment of the present invention;

FIG. 16 is a left side perspective view of a tongue and a tongue extension, illustrating a portion of an embodiment of the present invention;

FIG. 17 is a left perspective view of a trailer with a front pulley system. The front pulley cable originates at the winch, runs through the front pulley and underside the trailer frame until it connects at the back of the trailer.

FIG. 18 is a left perspective view of a trailer with a front pulley system. The front pulley cable originates at the winch, runs through the front pulley and underside the trailer frame until it connects at the back of the trailer.

FIG. 19 is a right perspective view of a trailer with a front pulley system. The trailer is shown with the front pulley system pulling the trailer into an upright, folded position. is a left perspective view of a trailer with a front pulley system. The front pulley cable originates at the winch, runs through the front pulley and underside the trailer frame until it connects at the back of the trailer.

### DETAILED DESCRIPTION

It will be readily understood that the components of the present invention, as generally described with reference to the drawings herein, could be implemented in a wide variety of different configurations. Thus, the following more detailed description of the embodiments of the system and method of the present invention, is not intended to limit the scope of the invention, but is merely representative of various embodiments of the invention. Unless explicitly described otherwise, using language similar to “at least one A, B, or C” should be interpreted as at least one A, at least one B, at least one C, or any combination thereof.[2]

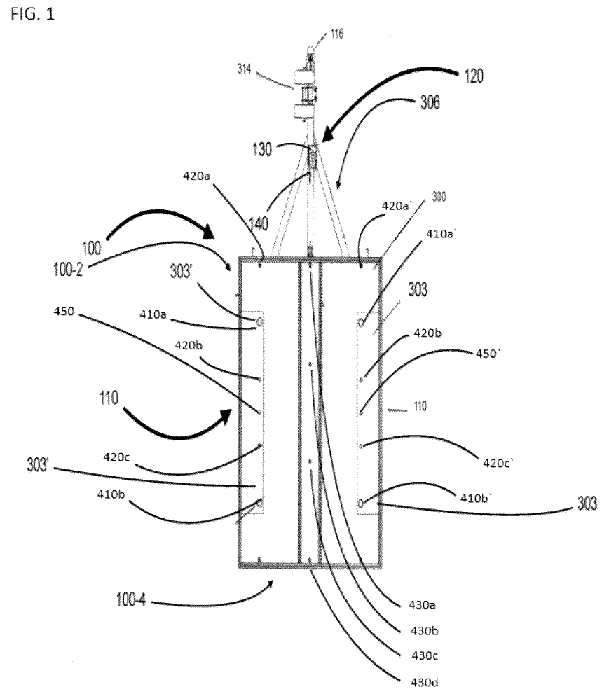

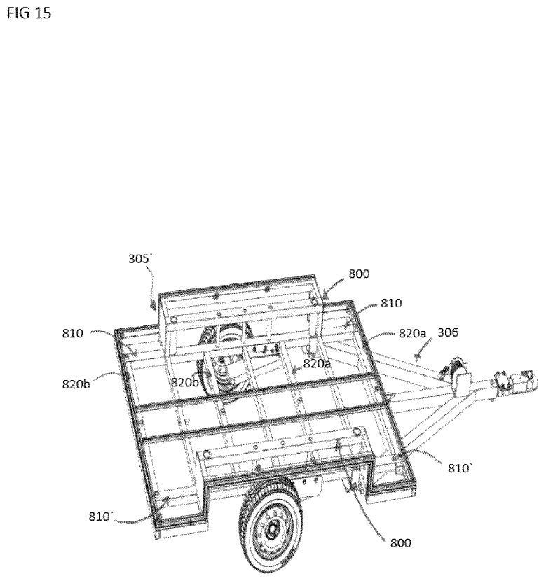

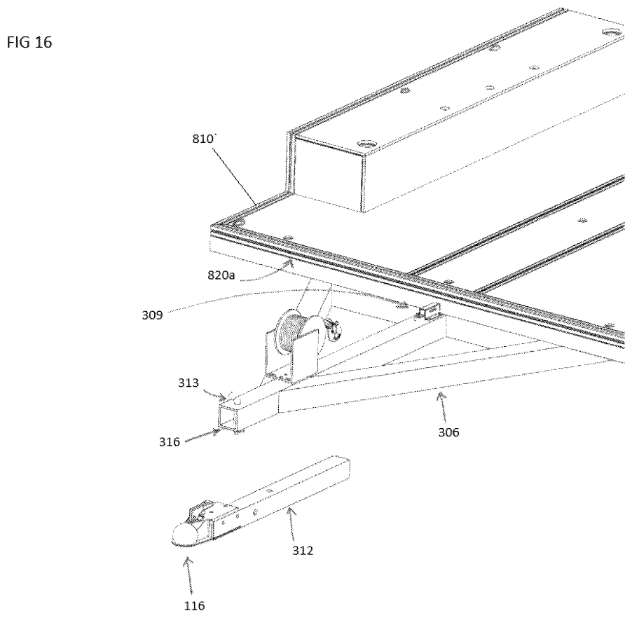

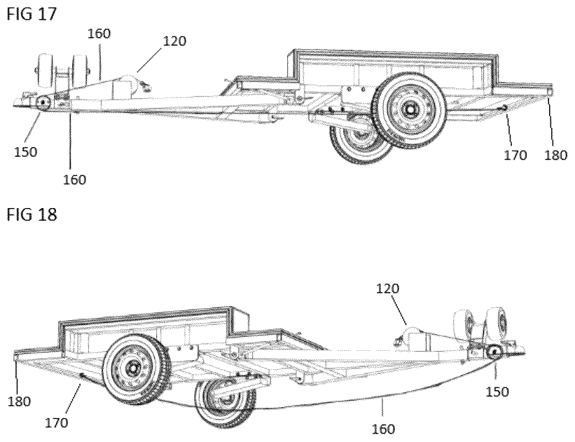

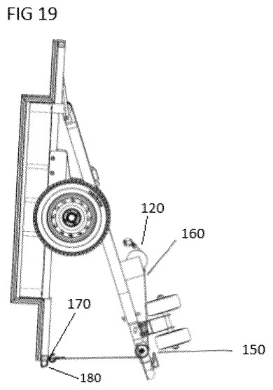

Referring to FIG. 1, an embodiment of a trailer system is disclosed; the trailer system may be a trailer configured to receive one or more detachably coupleable devices. In some embodiments, the trailer system may have a trailer detachably coupled to one or more devices. FIG. 1 depicts a trailer of a trailer system; the trailer may be a vertically-stowable trailer 100, which may have a trailer frame 110 (see FIG. 15 to see a broader view of the trailer frame 110). The vertically-stowable trailer 100 may have a winch-cable assembly 120; the vertically-stowable trailer 100 may be configured to vertically tilt the trailer an amount of degrees, such as substantially 90 degrees; in some embodiments, the vertically-stowable trailer 100 may stand stably at substantially 90 degrees. In FIG. 1, at least one winch 130 is shown and at least one cable 140 is shown; at least one cable 140 may be coupled to the at least one winch 130. Although the embodiment shown in FIG. T1 shows a winch-cable assembly 120, some embodiments of the trailer system are free from a winch-cable assembly 120.

In some embodiments, a trailer deck 300 may have dimensions between 72-82 inches for the length of a lateral side, and between 93-144 inches for the length of a longitudinal side. In some preferred embodiments, reasonable dimensions for a trailer deck 300 may have a lateral side length of 76 inches and a longitudinal side length of 120 inches.

A trailer deck 300 may be coupled to a trailer frame 110, as shown in FIG. 1. The trailer frame 110 may include one or more rails, and the rails may be one or more extrusion rails; the one or more extrusion rails may be one or more aluminum extrusion rails, steel extrusion rails, or any other type of extrusion rails. The one or more extrusion rails may be T-slot extrusion rails or V-slot extrusion rails. The trailer deck 300 may have one or more sleeve members, such as sleeve members 410a, 410b, 410a′, 410b′ 420a, 420b, 420c, 420d, 420a, 420b, 420c′, 420d′, 440a, 440b, 440a′, 440b; trailer deck 300 may also have one or more central sleeve members 430a, 430b, 430c, 430d. In some embodiments, some of the outer sleeve members may have a larger diameter than some of the outer sleeve members; some of the central sleeve members may have a larger diameter than some of the other central sleeve members. In some preferred embodiments, four or more of the sleeve members on the adaptable trailer-deck assembly align with four or more sleeve members on a watercraft, such that both the trailer and the watercraft may accept similarly-oriented detachable accessories. In some embodiments, large detachable accessories 900 and small detachable accessories 910 may be inserted into the sleeve members of the trailer and the watercraft may be cargo carriers, tents, housing units, watercraft carriers, or any other accessory for recreational or residential use.

In some embodiments, a depth range of one or more sleeve members is between 3 to 18 inches. In some embodiments, the depth range of one or more sleeve members is between 1 to 12 inches. In some embodiments, the depth range of one or more sleeve members is between 1 to 3 inches.

In some embodiments, the range of depth of sleeve members outlined above is between 50% to 200% of the written dimensions. In some embodiments, the range of depth of sleeve members outlined above is between 25% to 500% of the written dimensions.

In some preferred embodiments, the arrangement of sleeve members comprises four lateral crossmember large centered (LCLC) sleeve members 410a, 410b, 410a′, 410b′, eight lateral crossmember small lateral (LCSL) sleeve members 420a, 420b, 420c 420d, 420a′, 420b′, 420c′, 420d′, four longitudinal crossmember small centered (LCSC) sleeve members 430a, 430b, 430c, 430d, eight outer sleeve members 440a, 440b, 440c, 440d, 440a′, 440b, 440c′, 440d, and two interhull sleeve members 450, 450′. In some embodiments, four or more of the sleeve members in the arrangement of sleeve members align with four or more sleeve members on a watercraft.

In some preferred embodiments, the LCLC sleeve members are centered between LCSL sleeve members latitudinally and with a depth between 3 to 18 inches; the LCSL sleeve members are equally spaced by 6 to 26 inches in each direction from the center of an LCLC sleeve member, and parallel to a second LCLC sleeve member along the fender frame and with a depth between 1 to 12 inches; LCSC sleeve members are centered between LCSL sleeve members longitudinally and with a depth between 1 to 12 inches; outer sleeve members are equally spaced by 3 to 12 inches in each direction longitudinally and parallel to LCSL along the right and left sides of the trailer and with a depth between 1-12 inches; interhull sleeve members are centered laterally between the LCLC sleeve members, and with a depth of 1 to 3 inches. In some embodiments, the dimensions of the previously described arrangement of sleeve members are between 50%-200% of the written dimensions. In some embodiments, the dimensions of the previously described arrangement of sleeve members are between 25%-500% of the written dimensions.

While the above paragraph describes some possible embodiments of an arrangement of sleeves, the description is non-liming, and a plurality of possible sleeve member arrangements is allowed.

In some preferred embodiments, at least four sleeve members on the adaptable trailer-deck assembly align with at least four sleeve members on a watercraft for ease of use on both vehicles.

Referring to FIG. 1, trailer 100 may have a plurality of fenders 303, 303′; trailer 100 may have a front portion 100-2 and a rear portion 100-4. A tongue 306 may be coupled to the front portion 100-2. A trailer dolly 314 may be coupled to a tongue 306. A coupler 116 may be coupled to tongue 306. A fender, such as a right fender 303 and left fender 303′ may be an elevated portion of the trailer deck that contributes by supporting the weight of cargo, such as at least one accessory boat, and creating room for the suspension, wheels, and tires under the fenders; in some embodiments the fender is not an integral part of the trailer deck but is a separate piece that is coupled toot the trailer deck. Trailer frame 110 may support the weight of the cargo and may be coupled to trailer deck 300, which may be disposed within the trailer frame 110.

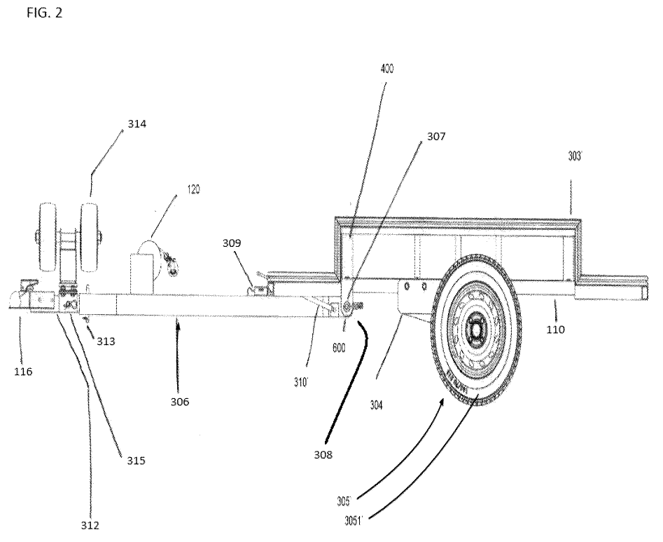

Referring now to FIG. 2, a side perspective view of some embodiments of a trailer system. The trailer frame 110 may be detachably coupled to a tongue 306 by means of a hinge 307; a hinge pin 308 may be placed in the hinge 307 to detachably secure the trailer frame 110 to the tongue 306, and the hinge pin 308 may be removed to remove the coupling of the trailer frame 110 from the tongue 306. Although the embodiment of FIG. 2 includes a hinge pin 308, some embodiments of the trailer frame will involve a hinge mechanism not limited to the use of a hinge pin 308.

A deck latch 309 may be attached to the trailer frame 110 or the tongue 306 to secure the trailer frame 110 to the tongue 306 in a locked towing position when activated. The deck latch 309 may be deactivated to allow the tongue 306 to angle away from the trailer frame 110 while still attached to the trailer frame at the hinge 307. This deactivation may allow the trailer system to vertically tilt when desired or remain secure and flat when desired.

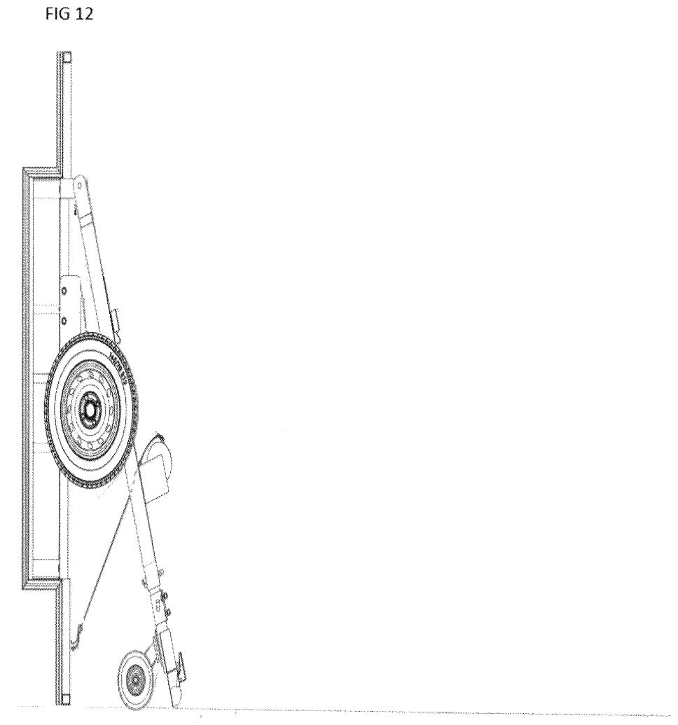

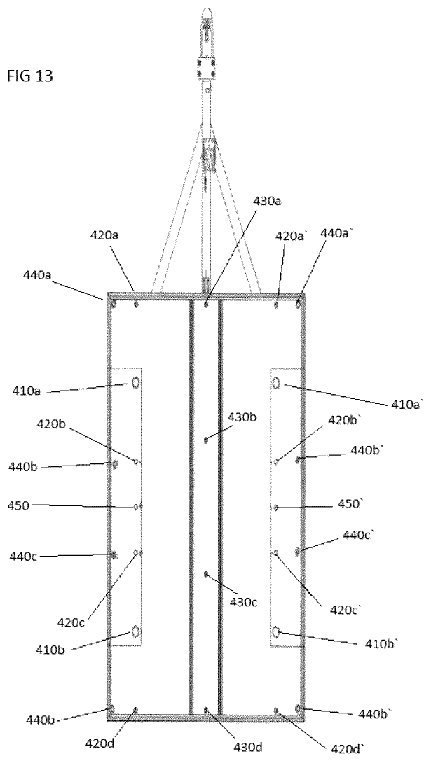

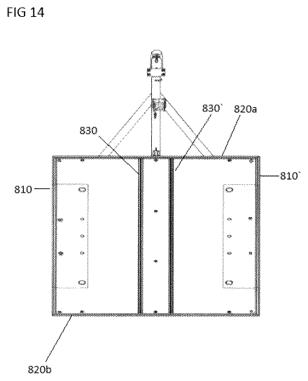

Some embodiments of the trailer system 100 have a removable tongue member 312 detachably connected to one end of a tongue 306. The removable tongue member 312 may be inserted into a tongue sleeve 316 and secured to the tongue 306 by an insertable tongue pin 313. Some embodiments of a removable tongue member 312 are detachably connected to a dolly 314 or secured in place by an insertable or removable dolly pin 315. The dolly 314 may be a wheel system. The dolly 314 may be detachably coupled to the removable tongue member 312 in any orientation relative to the removable tongue member 312. As shown in FIG. 2, the dolly 314 may be oriented in an upward position so that, when the trailer system 100 is placed with its wheels 305, 305′ on the ground, the dolly is facing away from the ground. The upward position of the dolly may be desired when towing the trailer system. A dolly may also be secured to a removable tongue member 312 in a downward position so that the dolly 314 points in the opposite direction of the upward position. The downward position of the dolly may be preferred to begin the transition from downward position to upward position, and the upward position may be desired when the trailer is vertically tilted as shown in FIG. 12.

Some embodiments of the removable tongue member 312 may be detachably coupled to a coupler 116.

Some embodiments of the trailer system 100 may include one or more tires 305, 305′ attached to the trailer frame 110.

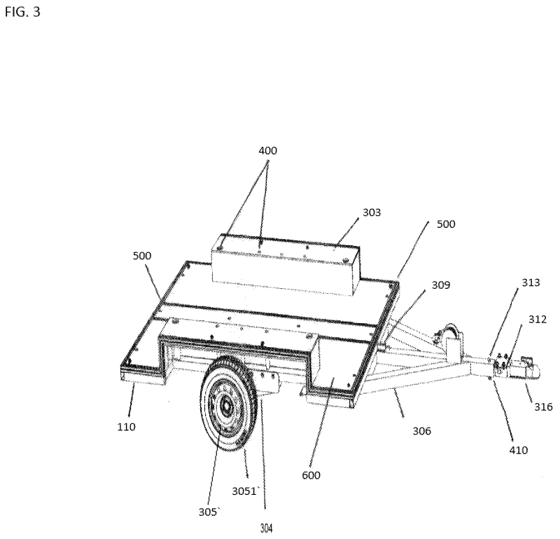

Referring to FIG. 3, suspension 304 may be disposed below the trailer frame 110; suspension 304 may absorb the irregularities in the road surface and may link the trailer frame to the axles and wheels 305, 305′ and tires 3051, 3051′.

A rail may be connected to the trailer frame 110. In some embodiments, the rail may be a modular rail. In some embodiments, the rails are connected to the rear of the trailer 100-4, the front of the trailer 100-2, any portion of the perimeter of the trailer, any portion of the body of the trailer, or any combination thereof. Said rails may be comprised of any material which allows for objects to be detachably coupled to the rails. In some embodiments, the rails may be attached to trailer walls. In some preferred embodiments, the rails are comprised of modular aluminum extrusion 500. The rails may function as a structural element and a functional element of the adaptable trailer-deck assembly.

In some embodiments, the front and back of the adaptable trailer-deck assembly may share the same placement of rails as the right and left sides of a watercraft. In some embodiments, the right and left sides of the trailer have rails placed on the outside of one or more outer sleeve members 400. In some embodiments, rails on the outside of outer sleeve members 400 align with the right and left sides of a watercraft where the rails are placed 3 to 12 inches on the inside of one or more outer sleeves.

In some embodiments, the deck may be made of a plastic composite 600. Additionally, two rails may be fixed to the trailer deck and may be placed in parallel, between 10 to 24 inches apart, and span longitudinally or laterally across the trailer.

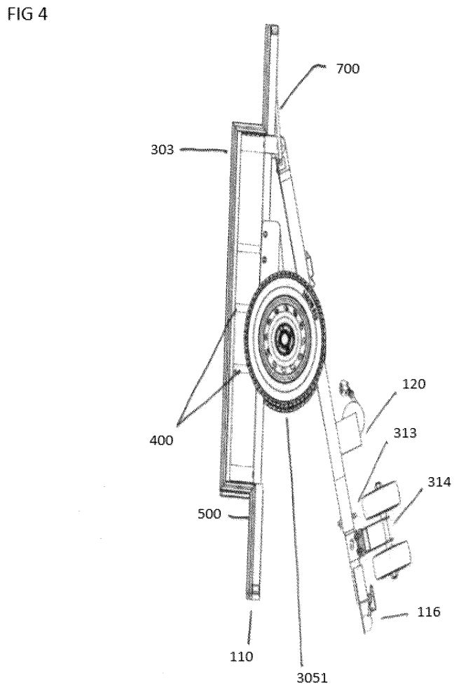

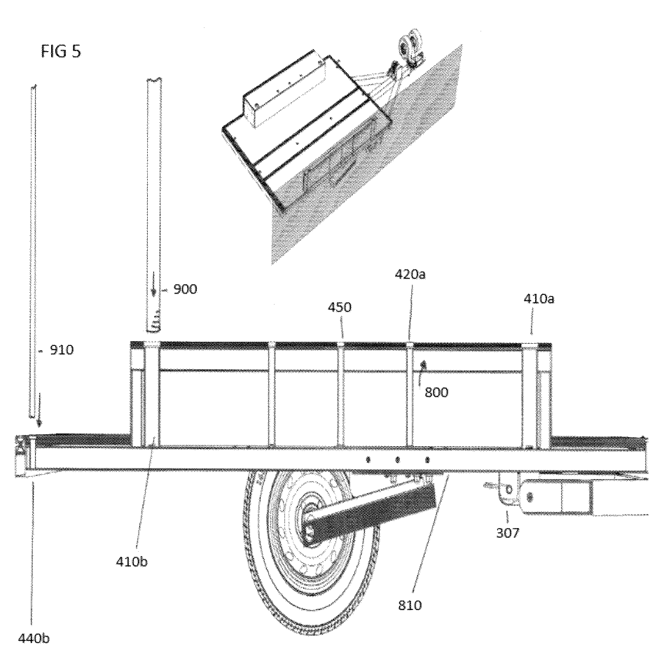

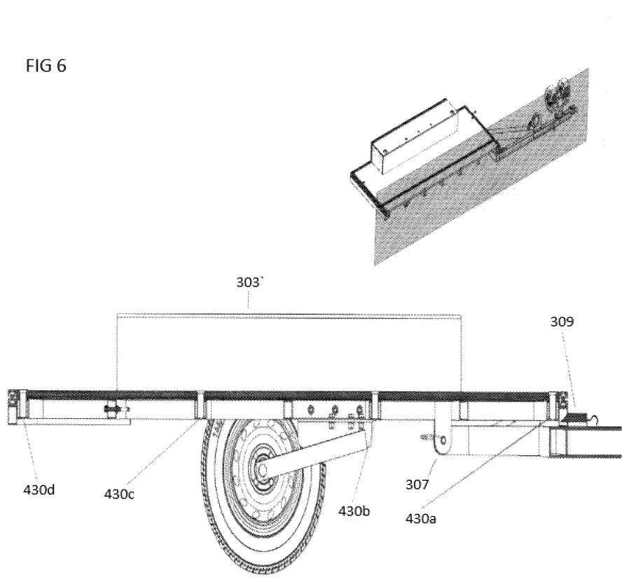

Now referring to FIG. 4, a possible configuration of a trailer 100 is shown, in which the trailer has been vertically tilted up to its standing storage position. The trailer frame 110 is detachably coupled to a tongue 306 by a hinge 307. A dolly 314 is detachably coupled in an upward position to a removable tongue member 312, itself being detachably coupled to the tongue 306. In some embodiments, a dolly 314 may be detachably coupled to a tongue 306 without first being coupled to a removable tongue member 312.

Some embodiments, as shown in FIG. 4, may include dampeners 700 to slow the opening of the trailer 100 when transitioning from a standing storage position to a towing position. Possible dampeners include, but are not limited to, gas dampeners, fluid dampeners, pneumatic dampeners, hinge dampeners, or any combination thereof.

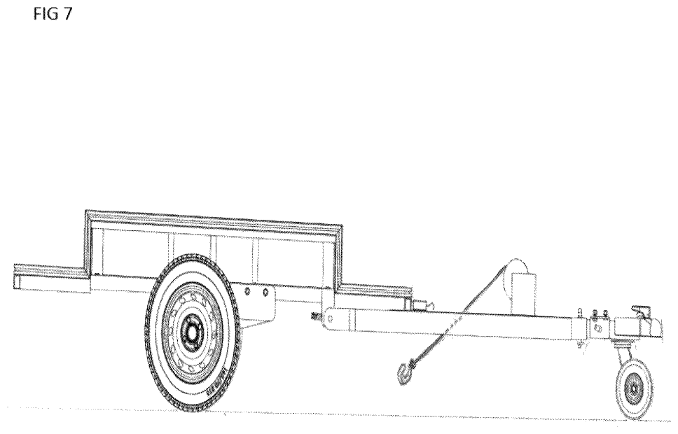

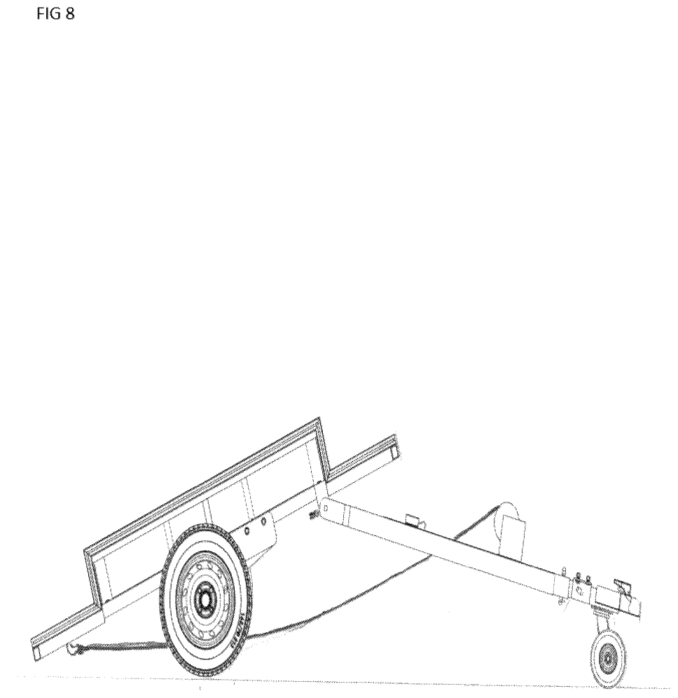

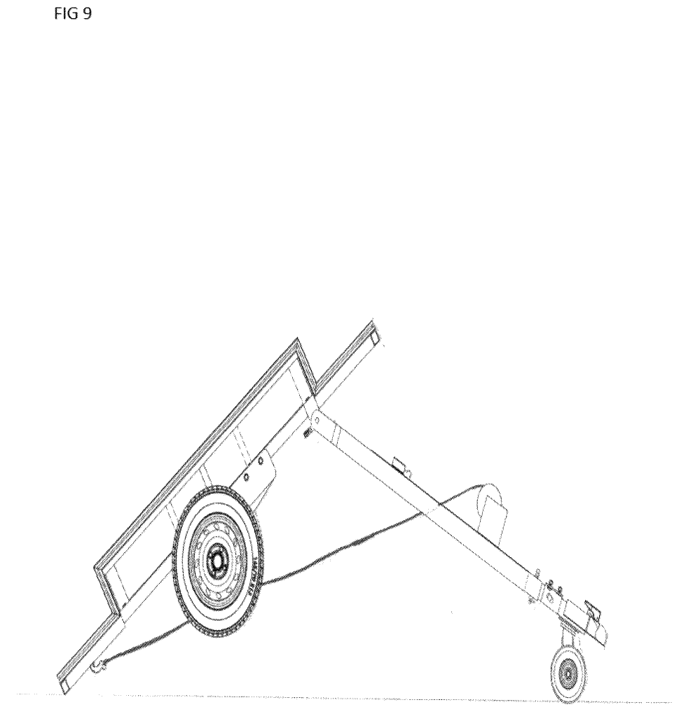

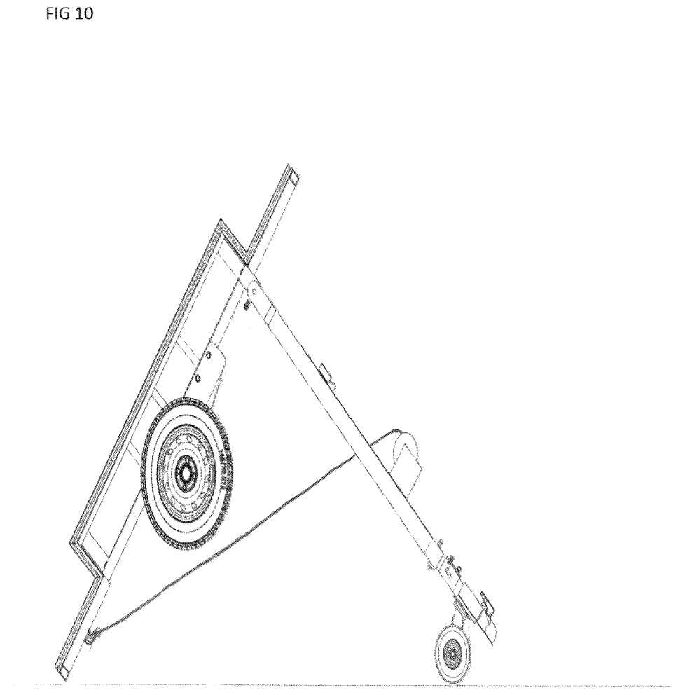

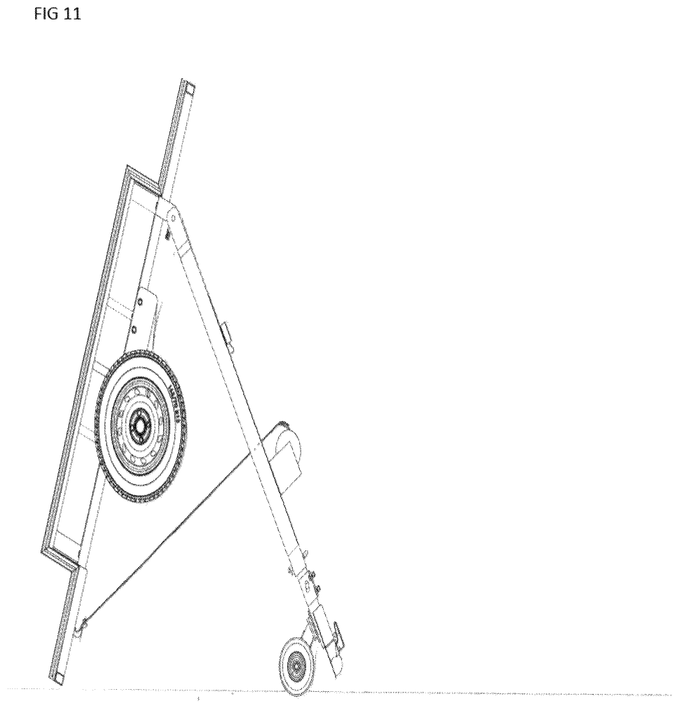

FIGS. 7 to 12 demonstrate some embodiments of a folding function of the trailer. A winch cable-assembly 120 may be detachably connected to a tongue 306. The winch-cable assembly 120 may include at least one winch 130, at least one cable 3111 and at least one hook 3112, a hook 3112 being connected to one end of a cable 3111. Said winch includes, but is not limited to, a battery-powered winch, a hand crank winch, or a drill. The hook end of the cable may be hooked removably to the trailer frame 110 as shown in FIG. 8. In some embodiments, the hook 3112 may be hooked to the rear portion of the trailer 100-4, or to another part of the trailer frame 110.

While the hook 3112 is coupled to the rear trailer frame 110, the trailer frame 110 may be detachably coupled to a tongue 306 at a hinge 307. The winch 130 may then be activated, applying force to a cable 3111, and pulling the trailer frame 110 towards the tongue 306, rotating around the hinge 307. This may bring the trailer 100 to a standing storage position, as shown in FIG. 12.

Referring to FIG. 15, some embodiments of a trailer frame 110 are shown. The trailer frame 110 may support the weight of any cargo and may be coupled to the trailer deck 300. Trailer deck 300 may be a platform that provides a surface area for the placement of cargo; trailer deck 300 may be configured to receive attachments. Trailer deck 300 may include any number of sleeve members in any number of arrangements. Some embodiments of trailer deck 300 may have two lateral beams, an upper lateral beam 800, 800′ and a lower lateral beam 810, 810′. The lower lateral beam placement may represent a modular aluminum extrusion pattern of beams that extend across the plane of the deck. These beams may each incorporate at least one sleeve member, such as seven sleeve members in some embodiments, and which may include portions of fenders 303, 303′. Longitudinal beams 820a and 820b may also be used for support and structure, and may be used in a modular aluminum extrusions pattern that extends across the deck in a longitudinal direction. Interhull beams 830 may be used on the trailer for additional structure and support.

In some embodiments, the trailer may include a front pulley system that enables the user to easily bend and fold the trailer, avoiding manual exertion from the user. A front pulley 150 may be mounted in an upright orientation on the side of the tongue sleeve 316, located behind the coupler 116. This front pulley may serve to reverse the direction of the front pulley cable 160 and may guide it downward toward the underside of the trailer tongue and along the bottom of the trailer frame 110. The cable or rope may then be fixed to a rear hook connection point 170 at the rear underside of the trailer frame 110. The user may be enabled to connect and disconnect the front pulley cable 160. When the winch 120 is activated and retracts the front pulley cable 160, the front pulley 150 may redirect the tension force so that the trailer tongue 306 is drawn rearward toward the underside of the trailer frame 110. This action may cause the tongue 306 to rotate downward and rearward around a hinge point located between the tongue and the trailer frame. The trailer frame 110, in turn, may rotate upward, transitioning the trailer from a horizontal to a vertical or tilted storage orientation. As the front pulley cable 160 is drawn in, the wheel of the dolly 314 may roll rearward, maintaining ground contact and supporting the tongue 306 while facilitating smooth motion toward the back of the trailer. The rear portion of the trailer frame may be equipped with stationary rubber bumpers 180 or pads which may make contact with the ground during the lifting process. These bumpers may provide two stable points of ground contact, while the dolly 314 under the tongue 306 may provide a third, resulting in a tripod-like ground support configuration. This configuration may enhance stability during the transition to the upright storage position. When fully actuated, the system may lift the trailer's wheels off the ground, allowing the trailer to be stably stored in a vertical position, minimizing the trailer's storage footprint.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A vertically-stowable trailer system comprising:
a trailer, the trailer comprising:
a trailer frame, which may be sized for towing behind a car;
a winch-cable assembly, which may be configured to vertically tilt the trailer substantially 90 degrees, comprising:
at least one winch;
at least one cable; and,
at least one attachment point;
an adaptable trailer-deck assembly coupled to the trailer frame, the trailer deck comprising at least one rail, wherein the at least one rail is selected from a group consisting of an extrusion, an aluminum extrusion, and a T-slot aluminum extrusion, wherein the adaptable trailer-deck assembly further comprises a plurality of sleeve members disposed in a pattern, wherein the plurality of sleeve members are each configured to receive insertable members.

2. The vertically stowable trailer system of claim 1 further comprising at least one attachable device directly coupled to the trailer deck selected from a group consisting of:
at least one cargo carrier;
at least on ATV carrier;
at least one PWC carrier;
at least one motorcycle carrier;
at least one bike rack;
at least one watercraft carrier;
at least one tent platform;
at least one housing unit;
at least one shelter accommodation; and
any combination thereof.

3. The vertically stowable trailer system of claim 1, wherein the trailer is operable to be towed by a car and maneuverable by only one person into an upright storage position.

4. The vertically stowable trailer system of claim 1, wherein the mechanical winch and cable system comprises:
the at least one winch mechanism is coupled to the trailer tongue;
at least one cable is coupled to the at least one winch mechanism at one end;
an end of the cable opposite the end coupled to the at least one winch mechanism being coupled to a hook; and,
a pulley attached to removable tongue member;
a attachment point at the rear underside of the trailer frame for the hook; and,
a control system operable to control the winch mechanism for tilting the trailer and positioning the trailer in a standing position.

5. The vertically-stowable trailer system of claim 1, wherein the trailer deck further comprises:
a plurality of modular aluminum extrusions forming the deck frame;
a plurality of sleeves integrated into or alongside the modular aluminum extrusions; and
a plurality of inserts configured to be inserted into the sleeves for attaching multipurpose attachments to the trailer deck.

6. The vertically-stowable trailer system of claim 1, wherein the trailer further comprises:
a hitch assembly for attachment to a car;
wheels for towing; and,
a dampening mechanism for slowing the transition from a stowing position to towing position;
a winch-cable assembly comprising:
at least one winch, at least one cable, and at least one hook.

7. A trailer system comprising:
a vertically-stowable trailer comprising:
a trailer frame;
a mechanical winch-cable assembly configured to vertically tilt the trailer substantially 90 degrees, wherein the winch-cable assembly comprises at least one winch mechanism and at least one cable;
a trailer deck coupled to the trailer frame, the trailer deck comprising at least one rail comprising material selected from a group consisting of extrusion, aluminum extrusion, and T-slot aluminum extrusion, the trailer deck comprising a plurality of sleeve members disposed in a pattern and each configured to receive at least one insertable member.

8. The vertically stowable trailer system of claim 7 further comprising at least one attachable device directly coupled to the trailer deck selected from a group consisting of:
at least one cargo carrier;
at least on ATV carrier;
at least one PWC carrier;
at least one motorcycle carrier;
at least one bike rack;
at least one watercraft carrier;
at least one tent platform;
at least one housing unit;
at least one shelter accommodation; and
any combination thereof.

9. The trailer of claim 7 is operable to be towed by a car and maneuvered by one person into an upright storage position.

10. The vertically stowable trailer system tilting and standing multipurpose trailer apparatus of claim 7, wherein the mechanical winch and cable system comprises:
the at least one winch mechanism coupled to the trailer tongue;
the at least one cable coupled to the at least one winch mechanism and connected to a tilting mechanism configured to tilt the trailer;
a pulley;
an attachment point; and,
a control system operable to control the winch mechanism for tilting and standing the trailer.

11. The tilting and standing multipurpose trailer apparatus of claim 7, wherein the trailer deck further comprises:
a plurality of modular aluminum extrusions forming part of the deck frame;
a plurality of sleeves integrated into and alongside the modular aluminum extrusions; and
a plurality of inserts configured to be inserted into the sleeves for attaching multi-purpose attachments to the trailer deck.

12. The tilting and standing multipurpose trailer apparatus of claim 7, wherein the at least one multi-purpose attachment comprises:
at least one cargo carrier;
at least on ATV carrier;
at least one PWC carrier;
at least one motorcycle carrier;
at least one bike rack;
at least one watercraft carrier;
at least one tent platform;
at least one housing unit;
at least one shelter accommodation; and
any combination thereof.

13. The tilting and standing multipurpose trailer apparatus of claim 7, wherein the trailer frame further comprises:
a hitch assembly for attachment to a car;
wheels for towing; and
a dampening mechanism for slowing the transition from a stowing position to towing position.

14. The trailer of claim 1 further comprising plastic decking.

15. The trailer of claim 1 further comprising decking comprising composite material.

15. A method for transitioning a trailer from a horizontal position into a standing position, comprising:
providing a vertically-stowable trailer system comprising:
a trailer, the trailer comprising:
a trailer frame, which may be sized for towing behind a car;
a winch-cable assembly, which may be configured to vertically tilt the trailer substantially 90 degrees, comprising:
at least one winch;
at least one cable; and,
at least one attachment point; and,
an adaptable trailer-deck assembly coupled to the trailer frame, the trailer deck comprising at least one rail, wherein the at least one rail is selected from a group consisting of an extrusion, an aluminum extrusion, and a T-slot aluminum extrusion, wherein the adaptable trailer-deck assembly further comprises a plurality of sleeve members disposed in a pattern, wherein the plurality of sleeve members are each configured to receive insertable members;
providing a cable or rope operably connected to a winch and extended along the trailer tongue through a pulley mounted upright on a side of the trailer tongue behind the coupler, wherein the pulley redirects the cable or rope downward;
providing a rear attachment point located on the rear underside of the trailer frame;
attaching the rear attachment point to the hook attached at the end of the cable or rope; and,
operating the winch-cable assembly to vertically tilt the trailer substantially 90 degrees.
